(19) United States
(12) Patent Application Publication
(10) Pub. No.: US 2011/0257058 A1
(43) Pub. Date: Oct. 20, 2011

(54) Detergent Composition

(76) Inventors: Nigel Patrick Somerville Roberts, Newcastle upon Tyne (GB); Neil Joseph Lant, Newcastle upon Tyne (GB)

(21) Appl. No.: 13/086,461

(22) Filed: Apr. 14, 2011

(30) Foreign Application Priority Data
Apr. 19, 2010 (EP) 10160354.6

(51) Int. Cl. C11D 17/00

(52) U.S. Cl. 510/276

(57) ABSTRACT

Detergent composition in free flowing particulate form, wherein the detergent composition has free flowing secondary particles having a particle size of from 200 μm to 1500 μm and has primary particles which have a particle size of from 2 μm to 50 μm and which have at least 80% by weight of insoluble polymeric material.

### FIELD OF THE INVENTION

The present invention relates to detergent compositions in free flowing particulate form. The composition comprises small particles containing insoluble polymeric material contained within larger free flowing particles.

### BACKGROUND OF THE INVENTION

The use of insoluble polymeric material in a detergent composition may allow the adjustment of the density or the volume of the detergent composition or of particles of the detergent composition. This may also be useful to increase the storage stability of the detergent composition as the insoluble polymeric material may act as a moisture sink. They can also be used to absorb and deliver liquids such as non-ionic surfactants.

The incorporation of insoluble polymeric material in detergent composition in free flowing particulate form may lead to the deposition of the insoluble polymeric material onto the product to be cleaned. For example, water insoluble materials contained in a fabric care composition may deposit on the fabrics during the cleaning process. Such depositions are typically not desirable for the consumer.

The incorporation of particles comprising insoluble polymeric material into detergent composition in free flowing particulate form may also lead to segregation problem. As a consequence, the particles comprising insoluble polymeric material may not be homogeneously present in the detergent composition. This may lead to inconsistent cleaning properties of the detergent composition, depending of the quantity of insoluble polymeric material present in a specific part of a detergent product.

Also, the incorporation of particles comprising insoluble polymeric material into a detergent composition may increase the dusting associated with the detergent composition.

The inventors have found that the above mentioned problems could be at least partially alleviated by the use of free flowing secondary particles of the invention comprising smaller primary particles containing insoluble polymeric material.

### SUMMARY OF THE INVENTION

As such, the invention concerns, according to one of its embodiments, a detergent composition in free flowing particulate form, wherein the detergent composition comprises free flowing secondary particles having a particle size of from 200 μm to 1500 μm and containing primary particles which have a particle size of from 2 μm to 50 μm and which comprise at least 80% by weight of insoluble polymeric material.

The invention concerns according to one of its embodiments, a process to prepare a detergent composition in free flowing particulate form, comprising the step of preparing free flowing secondary particles having a particle size of from 200 μm to 1500 μm by agglomerating primary particles which have a particle size of from 2 μm to 50 μm and which comprise at least 80% by weight of insoluble polymeric material.

Unless otherwise specified, all percentage and ratio are in weight.

### DETAILED DESCRIPTION OF THE INVENTION

### The Insoluble Polymeric Material

The detergent composition of the invention comprises insoluble polymeric material. Insoluble is to be understood as substantially insoluble in deionised water at 25° C. For the purpose of the invention, polymeric materials having a solubility below 0.1 g/l or 0.01 g/l or 0.001 g/l in water at 25° C. may be considered as insoluble.

Preferably, the insoluble polymeric material is organic. Organic fillers may be considered as more environmentally friendly than inorganic alternatives. The insoluble polymeric material may comprise polysaccharide.

The insoluble polymeric material may comprise and/or be derived from lignocellulosic biomass. The insoluble polymeric material may be derived from wood, agricultural and biofuel residues, and/or waste product derived from wood.

The insoluble polymeric material may comprise lignin, hemicellulose, and/or cellulose. Preferably, the insoluble polymeric material comprises cellulose.

The insoluble polymeric material may be substituted or unsubstituted. It may be mechanically, thermally, or chemically treated.

The insoluble polymeric material may have a molecular weight in the range of from 10 000 to 10 000 000, for example from 20 000 to 3 000 000, typically from 50 000 to 2 000 000, or even from 100 000 to 500 000 g/mol.

The detergent composition may comprise from 1% to 90%, or from 2% to 50%, or from 4% to 40%, or from 8% to 30%, or from 10% to 20% by weight, of insoluble polymeric material.

### The Free Flowing Particles

The detergent composition of the invention is in free flowing particulate form. The detergent composition comprises, and preferably is constituted of, free flowing particles. Preferably the detergent composition comprises at least 50% per weight or even at least 75% or at least 90% per weight of free flowing particles having a particle size of from 200 μm to 1500 μm.

Particle size may be measured by sieving.

The detergent composition comprises primary particles. At least part of the primary particles of the detergent composition comprise at least 80%, by weight of the primary particle, of insoluble polymeric material.

The detergent composition comprises secondary free flowing particles.

Primary particles are particles which have been agglomerated with other primary particles to form a bigger particle, the bigger particle is called a secondary particle. A plurality of primary particles may be agglomerated together by any suitable process, for example by agglomeration or by spray drying.

Secondary free flowing particles are free flowing particles that comprise a plurality of smaller primary particles.

The primary particles which have been agglomerated together are not free flowing. The secondary particles, which comprise a plurality of smaller primary particles, are free flowing.

At least part of the primary particles which comprise at least 80% of insoluble polymeric material have a particle size of from 5 μm to 50 μm. For example, at least 50%, or 70%, or 80% , or 90% of the primary particles which comprise at least 80% of insoluble polymeric material have a particle size of from 5 μm to 50 μm, or even of from 10 μm to 25 μm.

The detergent composition may comprise primary particles comprising at least 10% or 25% or at least 50% by weight of insoluble cellulose.

The detergent composition may comprise primary particles comprising at least 10% or 25% or at least 50% by weight of insoluble hemicellulose.

The detergent composition may comprise primary particles comprising at least 10% or 25% or at least 50% by weight of insoluble lignin.

The detergent composition may comprise primary particles prepared from lignocellulose sources.

The detergent composition may comprise primary particles which comprise at least 0.0001% or 0.001% of brightener, bleaching species and/or hueing dye. Those compounds may have been used to modify the colour of the insoluble polymeric material.

In the detergent composition, at least part, for example at least 50%, or 70%, or 80%, or 90%, of the primary particles which comprise at least 80% of insoluble polymeric material and which have a particle size of from 5 μm to 50 μm are contained in secondary free flowing particles which have a particle size of from 200 μm to 1500 μm.

At least part, for example at least 50%, or 70%, or 80%, or 90%, of the secondary particles, that contains free flowing particles having a particle size of from 5 μm to 50 μm and comprising at least 80% by weight of insoluble polymeric material, have a particle size of from 200 μm to 1500 μm, for example a particle size of from 300 μm to 1200 μm or of from 500 μm to 1000 μm.

The detergent composition may comprise at least 5%, or 10%, or 20% and up to 90% or 50% by weight of free flowing secondary particles.

The free flowing secondary particles may comprise at least 5%, or 10%, or 25%, or 50% or 75%, or 90% and up to 100% or 97% by weight of primary particles.

The detergent composition may comprise at least 5%, or 10% or 20% or 30% and up to 95% or 80% or even 60% by weight of primary particles which have a particle size of from 5 μm to 50 μm and which comprise at least 80% by weight of insoluble polymeric material, and which are contained in free flowing secondary particles having a particle size of from 200 μm to 1500 μm.

Preferably, at least 20%, or even at least 35% or 50% or 75% or 90%, and up to 100% or 97% by weight of the insoluble polymeric material present in the detergent composition is contained in primary particles which have a particle size of from 2 μm to 50 μm and which comprise at least 80% by weight of insoluble polymeric material, and which are contained in free flowing secondary particles having a particle size of from 200 μm to 1500 μm.

The secondary free flowing particles may be formed by agglomerating primary particles with water or a binder such as a surfactant which can be for example anionic or non-ionic or a polymer like a polyethyleneglycol.

The secondary free flowing particles may comprise at least 0.0001% or 0.001% of brightener, bleaching species and hueing dye. Those compounds may have been used to modify the colour of the particles.

Before being agglomerated in the free flowing secondary particles, the primary particles of insoluble polymeric material may have a density between 50 g/l to 600 g/l or even from 50 g/l to 200 g/l.

Before being incorporated in the detergent composition, the free flowing secondary particles may have a density between 50 g/l to 600 g/l or even from 50 g/l to 200 g/l.

The invention also concerns a process to prepare a detergent composition according to the invention wherein the free flowing secondary particles of the invention are prepared with insoluble polymeric material having a density of between 50 g/l to 600 g/l or even from 50 g/l to 200 g/l.

The invention also concerns a process to prepare a detergent composition comprising free flowing secondary particles of the having a density of between 50 g/l to 600 g/l or even from 50 g/l to 200 g/l.

### The Detergent Composition

The detergent composition may be capable of cleaning and/or softening fabric during a laundering process. The detergent composition may be a hair care, or a dish care composition.

The detergent composition may comprise one or more adjunct ingredient(s). The precise nature of these additional adjunct components, and levels of incorporation thereof, will depend on the physical form of the composition and the nature of the operation for which it is to be used.

The adjunct ingredients may be present in the free flowing secondary particle which comprise the primary particles, for example as a binder between the primary particles.

The adjuncts ingredient may also be present in other free flowing particles.

For example when the detergent composition is a fabric care composition, suitable adjunct materials include, but are not limited to surfactant, builder, flocculating aid, chelating agents, dye transfer inhibitors, enzymes, enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, hueing dyes, perfumes, structure elasticizing agents, fabric softeners, carriers, hydrotropes, processing aids, and/or pigments. In addition to the disclosure below, suitable examples of such other adjuncts and levels of use are found in U.S. Pat. Nos. 5,576,282, 6,306,812 B1 and 6,326,348 B1.

The detergent composition may comprise from 0.05% to 30% by weight of one or more surfactant(s). Preferably, the detergent composition comprises from 0.1% to 25% of surfactant, typically from 0.5% to 20%, or from 1% to 15%, or from 2% to 10% by weight of surfactant. The surfactant may be anionic, nonionic and/or cationic.

The detergent composition may comprise from 0.05% to 30% by weight of one or more anionic surfactant. The detergent composition may comprise 0.1% to 20%, in particular from 0.5% to 15% or from 1% to 13%, or even from 1.5% to 11% or from 2% to 8% by weight of anionic surfactant.

In particular, the anionic surfactant may comprise anionic surfactants selected from alkyl ester sulfonate(s); linear, branched, and modified alkylbenzene sulfonate(s); C₁₀-C₁₈ alkyl alkoxy sulfates; C₁₀-₂₀ primary, branched-chain and random alkyl sulfates; C₁₀-C₁₈ secondary (2,3) alkyl sulfates; C₁₀-C₁₈ alkyl alkoxy carboxylate(s); fatty acid(s); mid-chain branched alkyl sulfate(s); mid-chain branched alkyl alkoxy sulfate(s); alpha-olefin sulfonate(s); phosphate ester(s); and mixtures thereof.

The detergent composition may comprise a non-ionic surfactant. Where present the non-ionic surfactant(s) is generally present in amounts of from 0.01 wt % to 20 wt %, or from 0.1 wt % to 4 wt % by weight of the detergent composition.

The non-ionic surfactant can be selected from the group consisting of: alkyl polyglucoside and/or an alkyl alkoxylated alcohol; C₁₂-C₁₈ alkyl ethoxylates, such as, NEODOL® non-ionic surfactants from Shell; C₆-C₁₂ alkyl phenol alkoxylates wherein the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as described in more detail in U.S. Pat. No. 6,150,322; C₁₄-C₂₂ mid-chain branched alkyl alkoxylates, BAEx, wherein x=from 1 to 30, as described in more detail in U.S. Pat. No. 6,153,577, U.S. Pat. No. 6,020,303 and U.S. Pat. No. 6,093,856; alkylpolysaccharides as described in more detail in U.S. Pat. No. 4,565,647, specifically alkylpolyglycosides as described in more detail in U.S. Pat. No. 4,483,780 and U.S. Pat. No. 4,483,779; polyhydroxy fatty acid amides as described in more detail in U.S. Pat. No. 5,332,528, WO 92/06162, WO 93/19146, WO 93/19038, and WO 94/09099; ether capped poly(oxyalkylated) alcohol surfactants as described in more detail in U.S. Pat. No. 6,482,994 and WO 01/42408; and mixtures thereof.

The detergent composition may comprise a cationic surfactant. When present, preferably the detergent composition comprises from 0.01 wt % to 10 wt %, or from 0.1 wt % to 2 wt % cationic detersive surfactant.

Suitable cationic detersive surfactants are alkyl pyridinium compounds, alkyl quaternary ammonium compounds, alkyl quaternary phosphonium compounds, and alkyl ternary sulphonium compounds. The cationic detersive surfactant can be selected from the group consisting of: alkoxylate quaternary ammonium (AQA) surfactants as described in more detail in U.S. Pat. No. 6,136,769; dimethyl hydroxyethyl quaternary ammonium surfactants as described in more detail in U.S. Pat. No. 6,004,922; polyamine cationic surfactants as described in more detail in WO 98/35002, WO 98/35003, WO 98/35004, WO 98/35005, and WO 98/35006; cationic ester surfactants as described in more detail in U.S. Pat. No. 4,228,042, U.S. Pat. No. 4,239,660, U.S. Pat. No. 4,260,529 and U.S. Pat. No. 6,022,844; amino surfactants as described in more detail in U.S. Pat. No. 6,221,825 and WO 00/47708, specifically amido propyldimethyl amine; and mixtures thereof.

Cationic surfactants may be chosen among mono-C₈₋₁₀ alkyl mono-hydroxyethyl di-methyl quaternary ammonium chloride, mono-C ₁₀₋₁₂ alkyl mono-hydroxyethyl di-methyl quaternary ammonium chloride and mono-C₁₀ alkyl mono-hydroxyethyl di-methyl quaternary ammonium chloride. Cationic surfactants such as Praepagen HY (tradename Clariant) may be useful and may also be useful as a suds booster.

The detergent composition of the invention may comprise a builder. When a builder is used, the detergent composition will typically comprise from 1% to about 40%, typically from 2 to 20%, or even from about 4% to about 15%, or from 5 to 10% by weight of builder(s).

The detergent composition may comprise from 1% to about 40%, typically from 2 to 20%, or even from about 4% to about 15%, or from 5 to 10% by weight of builder(s), chelant(s), or, in general, any material which will remove calcium ions from solution by, for example, sequestration, complexation, precipitation or ion exchange.

The detergent composition may comprise a chelant. Suitable chelants include diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid (EDDS) and/or hydroxyethane diphosphonic acid (HEDP). Preferably the ethylene diamine-N′N′-disuccinic acid is in S′S′ enantiomeric form. The composition of the invention may comprise less than 3% or less than 2% or 1% or 0.5% of each of the above mentioned chelants.

Builders include, but are not limited to, the alkali metal, ammonium and alkanolammonium salts of polyphosphates, alkali metal silicates, layered silicates, such as SKS-6 of Clariant®, alkaline earth and alkali metal carbonates, aluminosilicate builders, such as zeolite, and polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, fatty acids, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

The detergent compositions of the present invention may comprise from 0 to 50%, in particular from 1% to 25%, or less than 20%, or less than 15%, by weight of sodium carbonate.

Preferably, the detergent composition comprises a dispersant. The detergent composition may comprise at least 0.2% or 0.4% or 0.6% or 0.8% or 1% by weight of dispersant, such as carboxymethyl cellulose.

Preferably, the detergent composition has a density of between 300 g/l and 800 g/l, for example of from 350 g/l to 600 g/l. or from 400 g/l to 500 g/l.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

The following examples are given by way of illustration only and therefore should not be construed to limit the scope of the invention.

### EXAMPLES

### Example 1

### Preparation of a Free Flowing Particulate Detergent Composition

NK-100® (supplied by Rettenmaier) ground corn cob material is further ground to particles having a d50 of 20 μm using an Air Classifier Mill.

10 g of solid sodium hydroxide pellets are added to 500 g of water at ambient temperature. 75 g of the further ground NK-100 is added to the sodium hydroxide solution and stirred for 10 minutes. A bleaching agent such as sodium percarbonate can optionally be added at this stage.

75 g of Arbocel BE-600® particles (supplied by Rettenmaier) is then added to the mixture above and stirred in. Arbocel BE-600 is a finely ground cellulose material.

The resulting mixture then has 9 g of HLAS added to it during stirring in a Kenwood K-blade food mixer resulting in a material similar to a meringue or cake mix. Dyes can be added at this stage to alter the colour if desired.

This mix is then spread out thinly on a tray (˜1 cm depth) and dried in an oven overnight at 60 ° C. The resulting “biscuit” like mix is then pushed through a 1.7 mm sieve to give the final free flowing secondary particles comprising primary particles of further ground NK-100 and of Arbocel BE-600.

### Example 2

### Preparation of a Free Flowing Particulate Detergent Composition

A detergent slurry is made from the following ingredients

15 kg of 45% active LAS paste

12 kg of sodium sulphate

3 kg of sodium silicate solution (40% active)

1.8 kg of polycarboxylate solution (Sokalan CP 5®)

8 kg sodium carbonate

400 g of CMC

4 kg of Arbocel BE-600

75 kg of water

The slurry is mixed at 60° C. and then spray-dried at an air inlet temperature of 180° C. and a rate of 45 kg/hr. This gives free flowing secondary particles of density 400 g/litre and a mean particle size of 300 microns.

### Example 3

### Preparation of a Free Flowing Particulate Detergent Composition

A detergent slurry (Slurry 1) is made from the following ingredients

12 kg of 45% active LAS paste

12 kg of sodium sulphate

1 kg of sodium silicate solution (40% active)

1.8 kg of polycarboxylate solution (Sokalan CP 5)

8 kg sodium carbonate

400 g of CMC

60 kg of water

A second slurry (Slurry 2) is then prepared as follows

15 kg of water

4 kg of Arbocel BE-600

3 kg of 45% active LAS paste

2 kg of sodium silicate (40% active)

Slurry 1 is mixed at 60° C. and then spray-dried at an air inlet temperature of 180° C. and a rate of 45 kg/hr.

Slurry 2 is mixed at ambient and then co-spray dried along with Slurry 1 at a rate of 11.3 kg/hr.

The resulting particles from spray-drying Slurry 1 and Slurry 2 have a density of 380 g/l and a mean particle size of 270 microns.

### Example 4

### Preparation of a Free Flowing Particulate Detergent Composition

A detergent slurry (Slurry 1) is made from the following ingredients

15 kg of 45% active LAS paste

12 kg of sodium sulphate

3 kg of sodium silicate solution (40% active)

1.8 kg of polycarboxylate solution (Sokalan CP 5)

8 kg sodium carbonate

400 g of CMC

60 kg of water

A second slurry (Slurry 2) is made as follows.

4 kg of Arbocel BE-600 is mixed with 15 kg of water.

Slurry 1 is pumped from a crutcher at 45 kg/hr through a pipe. Prior to spray-drying, 8.6 kg/hr of Slurry 2 are injected into the pipe containing Slurry 1. The combined mix (Slurry 3) is then spray-dried at 190° C. to give particle of density 410 g/l and a mean particle size of 330 μm.

Adjunct detergent ingredients may be further admixed to the particles of examples 1-4.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition in free flowing particulate form, wherein the detergent composition comprises free flowing secondary particles having a particle size of from 200 μm to 1500 μm and containing primary particles which have a particle size of from 2 μm to 50 μm and which comprise at least 80% by weight of insoluble polymeric material.

2. The detergent composition according to claim 1, comprising at least 5% by weight of said free flowing secondary particles.

3. The detergent composition according to claim 1, wherein said free flowing secondary particles comprise at least 5% by weight of said primary particles.

4. The detergent composition according to claim 1, comprising at least 10% by weight of primary particles which have a particle size of from 2 μm to 50 μm and which comprise at least 80% by weight of insoluble polymeric material, and which are contained in free flowing secondary particles having a particle size of from 200 μm to 1500 μm.

5. The detergent composition according to claim 1, wherein at least 50% by weight of the insoluble polymeric material present in the detergent composition is contained in primary particles which have a particle size of from 2 μm to 50 μm and which comprise at least 80% by weight of insoluble polymeric material, and which are contained in free flowing secondary particles having a particle size of from 200 μm to 1500 μm.

6. The detergent composition according to claim 1, wherein the primary particles comprise at least 50% by weight of insoluble cellulose.

7. The detergent composition according to claim 1 comprising at least 5% of free flowing secondary particles having a particle size of from 300 μm to 1000 μm.

8. The detergent composition according to claim 1 comprising primary particles having a particle size of from 10 μm to 25 μm.

9. The detergent composition according to claim 1 having a density of between 300 g/l to 600 g/l.

10. The detergent composition according claim 1, wherein at least 90% per weight of the particles of the detergent composition have a particle size above 350 μm.

11. A process to prepare the composition of claim 1 wherein the free flowing secondary particles of the invention are prepared with insoluble polymeric material having a density of between 50 g/l to 600 g/l or even from 50 g/l to 200 g/l.

12. A process to prepare a detergent composition in free flowing particulate form, comprising the step of preparing free flowing secondary particles having a particle size of from 200 μm to 1500 μm by agglomerating primary particles which have a particle size of from 2 μm to 50 μm and which comprise at least 80% by weight of insoluble polymeric material.
